(19) United States
(12) Patent Application Publication
(10) Pub. No.: US 2006/0024649 A1
(43) Pub. Date: Feb. 2, 2006

(54) Handheld math problem solving device

(76) Inventor: David H. Vernon, Dallas, TX (US)

Correspondence Address: CARSTENS & CAHOON, LLP, P O BOX 802334, DALLAS, TX, 75380, US

(21) Appl. No.: 10/903,111

(22) Filed: Jul. 30, 2004

(51) Int. Cl. G09B 5/00

(52) U.S. Cl. 434/201

(57) ABSTRACT

The present invention provides a handheld device for aiding students in solving mathematical problems. Rather than solving the problem for the student it provides a graphical environment where students can step through the solution process exactly as they would on paper. The invention monitors the solution process, reinforcing correct steps, pointing out errors in incorrect steps, and providing hints or help as required. The invention simply enforces the hard and fast rules of arithmetic and mathematics as the student performs steps in solving a problem and notifies the student when those rules are violated. This approach is in sharp contrast to other calculators which can only solve problems (or pieces of problems) for the student.

### BACKGROUND OF THE INVENTION

1. Technical Field

The present invention relates generally to educational software, and more specifically to a handheld device that monitors user solutions to math problems and provides feedback to the user in real time.

2. Description of Related Art

Handheld calculators have become common, and seemingly indispensable, tools. Over the last several decades, calculators have become increasingly incorporated into mathematical curricula. However, as educational tools, traditional calculators are very limited in teaching basic math skills, since the machine does the calculation for the student, rather than teaching the student how to work out the problem.

Similarly, mathematical software is rapidly growing in popularity, both in schools and for home use. Such programs enable the user to work with mathematics but do not actually help the user learn to perform the mathematical operations. Instead, the programs simply require the user to provide an initial input, and then the software performs the necessary operations automatically, like a calculator. Other educational programs do provide instruction concerning the individual steps involved in mathematical operations. However, these programs specifically direct the student through the steps of solving a problem, and tend to enforce a particular educational rubric or methodology.

Therefore, it would be desirable to have a handheld device similar to a calculator that allows users to solve mathematical problems in a self-directed manner, while providing constant feedback on the user's actions, according to the fundamental rules of arithmetic and mathematics.

### SUMMARY OF THE INVENTION

The present invention provides a handheld device for aiding students in solving mathematical problems. Rather than solving the problem for the student it provides a graphical environment where students can step through the solution process exactly as they would on paper. The invention monitors the solution process, reinforcing correct steps, pointing out errors in incorrect steps, and providing hints or help as required. The invention simply enforces the hard and fast rules of arithmetic and mathematics as the student performs steps in solving a problem and notifies the student when those rules are violated. This approach is in sharp contrast to other calculators which can only solve problems (or pieces of problems) for the student.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows one embodiment of the handheld device with which the present invention is implemented;

FIG. 2 depicts a block diagram of a data processing system in which the present invention may be implemented;

FIG. 3 shows a display featuring an addition problem in accordance with the present invention;

FIG. 4 shows a display featuring a subtraction problem in accordance with the present invention;

FIG. 5 shows a display featuring a multiplication problem in accordance with the present invention;

FIG. 6 shows a display featuring a division problem in accordance with the present invention;

FIG. 7 shows a display featuring the solution of an expression in accordance with the present invention;

FIG. 8 depicts a flowchart illustrating the process of monitoring student input and providing feedback in accordance with the present invention; and

FIG. 9 depicts a flowchart illustrating the steps of converting an input statement into an n-ary tree;

FIG. 10 depicts a flowchart illustrating the process of removing extraneous sub-expressions in accordance with the present invention;

FIG. 11 depicts a flowchart illustrating the process of refactoring common sub-expressions after extraneous sub-expressions have been removed in accordance with the present invention;

FIG. 12 depicts a flowchart illustrating the substitution checking process in accordance with the present invention;

FIG. 13 shows the user interface for graphing inequalities;

FIG. 14 shows the user interface for graphing functions;

FIG. 15 shows two methods of working with clocks; and

FIG. 16 shows an interface for working with bill and coin denominations.

### DETAILED DESCRIPTION OF THE INVENTION

The present invention is a new type of calculator. There is a basic design principal which underlies all of its modes of operation, and distinguishes it from other calculators. Rather than solving the problem for the student it provides a graphical environment where students can step through the solution process exactly as they would on paper. The invention monitors the solution process, reinforcing correct steps, pointing out errors in incorrect steps, and providing hints or help as required. The invention simply enforces the hard and fast rules of arithmetic and mathematics as the student performs steps in solving a problem and notifies the student when those rules are violated. This approach is in sharp contrast to other calculators which can only solve problems (or pieces of problems) for the student.

The invention is customized for the student on a per grade level basis. Because it is designed to allow students to solve their problems interactively on the calculator, the operation of the calculator software changes as the student progresses through the math curriculum. This is accomplished by swapping out software cartridges on the handheld device. The software cartridges may be color coded for easy recognition in a classroom setting, allowing teachers to make sure that students are using the appropriate software.

To understand why the software needs to change for different grade levels, consider a second grader learning multiple digit multiplication and a seventh grader learning the order of operations. The second grader needs to be working out the multiplication the long way, since that is the focus of the lesson. On the other hand, the seventh grader is focusing on the order of operations, in which case working out the multiplication the long way might be an unnecessary distraction.

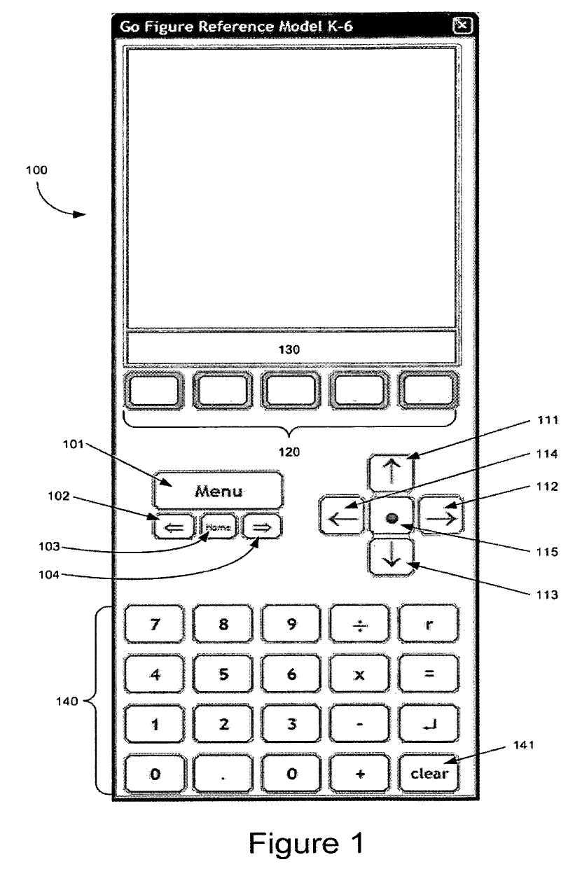

FIG. 1 shows one embodiment of the handheld device with which the present invention is implemented. This embodiment of the handheld device 100 is designed for use in lower grade levels, i.e. kindergarten through sixth grade. Power is activated by pressing any key and can turned off either through a menu option or from inactivity for a prescribed period, e.g. two minutes. The Menu button 101 is a toggle that activates the menu when it is pressed once, and then deactivates the menu when pressed again. The menu structure is hierarchal and preserves its state, meaning when the user brings up the menu it comes up where the user last left it. The Home 102 button takes the user to the top of the menu structure. The back (←) button 103 (below the Menu button) takes the user back one level. The forward (→) button 104 takes the user forward one level. Essentially buttons 103 and 104 work just like their counterparts on a web browser.

A user can select an assignment out of the menu. The back 103, forward 104, and home 102 buttons move the user through the assignment. The assignments home page shows the user's stats on that assignment. If the user does not select an assignment, the menu displays a default “untitled” assignment. The user can work problems and use the clear button 141 to delete it and do another. Alternatively, the user can use the back 103 and forward 104 buttons to work on several problems at the same time. Therefore, the invention has both an assignment mode and a “free use” mode.

Assignments (straight from popular math textbooks) can be preloaded in the software cartridges and accessed from an assignments menu. Assignments come in two forms: exercises and tests. Tests differ from exercises in that they are password protected (so that they can only be accessed in a classroom setting) and because the help and hint features of the calculator are disabled during a test.

The four arrow keys 111-114 with an action button 115 in the middle represent a modified “D Pad” similar to those featured on a handheld video game device (e.g., Nintendo Game Boy®). The primary difference from standard video game D Pads is the action button 115 in the middle, which is used to activate menu items.

The top five buttons 120 under the display are “soft keys”. If one of the soft keys is pressed when the menu is up, the currently active menu option becomes bound to that soft key, and an icon or label will appear in the screen section 130 directly above the soft key in question.

The remaining keys 140 comprise a slightly modified, classic calculator layout.

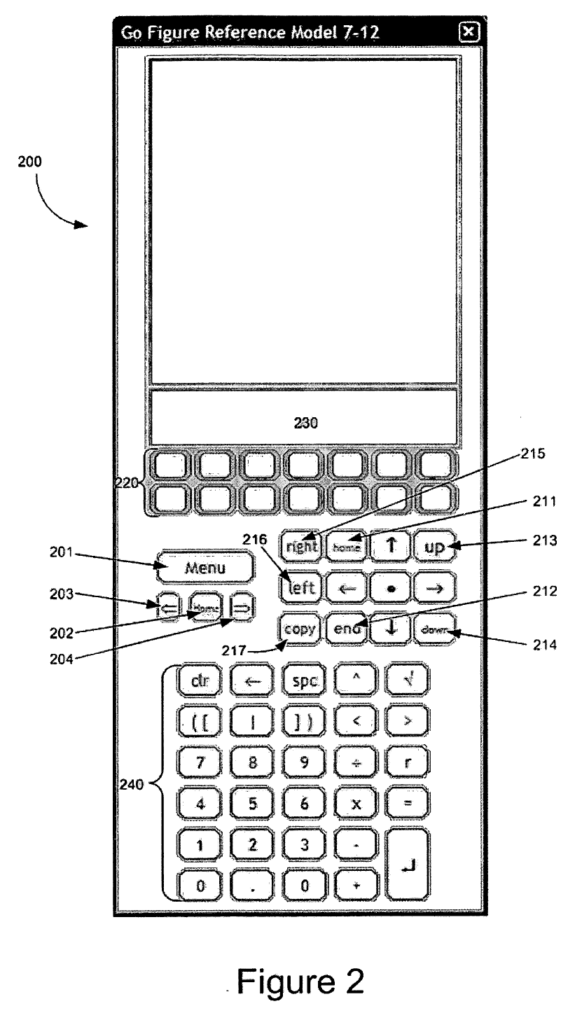

FIG. 2 shows an alternate embodiment of the handheld device with which the present invention is implemented. This alternate key layout 200 is designed for use in higher grade levels, i.e. seventh through twelfth grade, and includes additional buttons needed for solving higher math problems.

Similar to the first layout 100 in FIG. 1, the alternate embodiment 200 includes a menu button 201, and home 202, back 203, and forward 204 buttons. However, the “D Pad” on the second layout 200 is considerably enhanced.

In addition to the arrow keys and action button, the D Pad on the second embodiment 200 includes special keys for dealing with more complicated math problems than those solved with the first device 100. The D Pad “Home” button 211 takes the user to the beginning of a line, while the “End” button 212 takes the user to the end of the line. The “Up” button 213 moves the cursor up a line (for copy down), and the “Down” button 214 returns the cursor to the lower line. The difference is that the arrow keys are used for moving the cursor around within a given area of the screen. The up/down keys move the cursors “focus” from one area of the screen to another. For example in the algebra mode, the arrows would move the cursor from the numerator to the denominator. The Up/Down keys would be from line 5 to line 4 and back. That's the difference. The Right 215, Left 216, and Copy 217 buttons on the D Pad activate the “Copy down right hand side”, “Copy down left hand side”, and “Copy down selection” features, respectively.

There are two rows of soft keys 220, and space 230 on the display for two rows of icons/labels that can be assigned to the soft keys. The remaining keys 240 comprise a slightly modified, classic calculator layout similar to the K-6 layout 100, but with more advanced function keys.

Both embodiments 100, 200 of the handheld device include connectivity to a PC application with a PDA styled “Hot Sync” feature. This application contains the teacher's data capture, admin tool, assessment, and feedback. Connectivity can be via, e.g., USB, Firewire, Bluetooth, etc., and does not need very much bandwidth. The present invention may also use installable software packages that can be loaded via cartridges or from the pc application, or by other means. These software packages target specific grade levels (with different types of calculation modes) and curriculum packages (with different assignments).

The two key/button layouts 100, 200 do not necessarily have to be two different handheld devices. The keys can be on a removable daughter card. However, the grade 7-12 functions will require greater resolution due to the greater complexity of the problems on the display. The decision to use one device with changeable key layouts or separate devices is primarily a business decision, as the invention can be implemented either way.

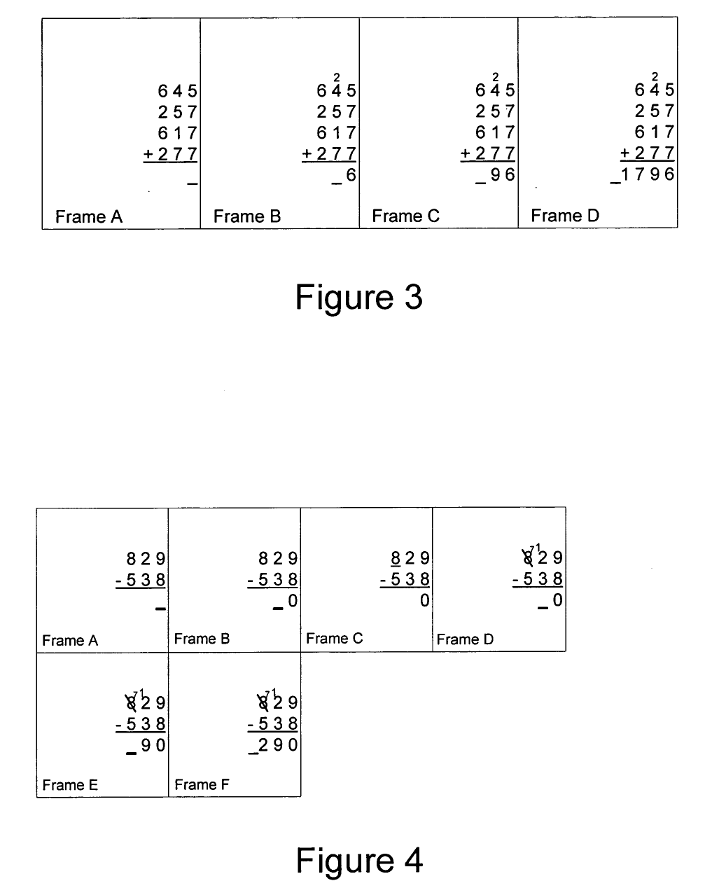

FIG. 3 shows a display featuring an addition problem in accordance with the present invention. This mode provided allows the user to work out a single or multiple row and column addition problem. Frames A through D are snapshots taken at several different points as the problem 645+257+617+277 is being solved.

Frame A shows the display immediately after the problem has been entered. The cursor is underneath the rightmost column of numbers. Typically, a student would solve this problem by working right to left through the intermediate steps, carrying as necessary, but the invention does not require this. The invention allows students to move freely along this row (with the left and right arrow keys of the D Pad) and up into the carry row (using the up and down arrows).

Frame B shows the student solving the first sub-problem: 5+7+7+7=26. Note that the carry digit (2) is shown above the next column to the left. Note also that in Frame C, the carry digit for the next sub-problem (2+4+5+1+7=19) is not shown. The student is free to use the carry digit or not, depending on skill level and confidence.

Frame D shows the final solution to this addition problem.

The underlying data structure of the arithmetic problem depicted in FIG. 3 is organized into cells. These cells are arranged from left to right and from top to bottom. Each cell is also designated as visible or invisible. Referring to Frame A in FIG. 3, the numbers listed in the addition problem (the cells above the addition line) are visible. The numbers in the cells below the addition line, which constitute the answer, are invisible. These invisible numbers are known to the calculator, which has already calculated the answer and is waiting to see if the user's input in the answer cells matches the correct number(s). This concept applies to carry and borrow numbers as well.

Therefore, in Frame A of FIG. 3, the cells containing the numbers 645, 257, 617, and 277 are visible, and the cells containing the numbers 1796 (the answer) are not visible. As the user enters numbers into the invisible answer cells, the device compares them to the numbers that should be there. If the user's input differs from the pre-determined, invisible numbers, an error indication (explained below) is returned to the user.

This underlying approach to the data structure is applied across the board to the other types of arithmetic problems described below.

FIG. 4 shows a display featuring a subtraction problem in accordance with the present invention. This is the mode provided to allow the student to work out single or multiple digit subtraction problems. Due to the nature of subtraction, multiple column subtraction is not supported. Frames A through F are snapshots taken at several different points as the problem 829-539 is being solved.

Frame A shows the display immediately after the problem has been entered. The cursor is underneath the rightmost column of numbers. As explained above, the user is free to move the cursor around.

Frame B shows the display after the first sub-problem (9−9=0) has been solved.

Frame C shows the display after the user has moved the cursor up to “borrow” from the 8 in the third column. Like carrying in addition, the borrowed is optional. Frame D shows the display after the borrow has been performed, with the eight 8 crossed out and replaced by a 7, and the borrowed 1 next to the 2.

Frames E and F show the last two steps in solving this problem.

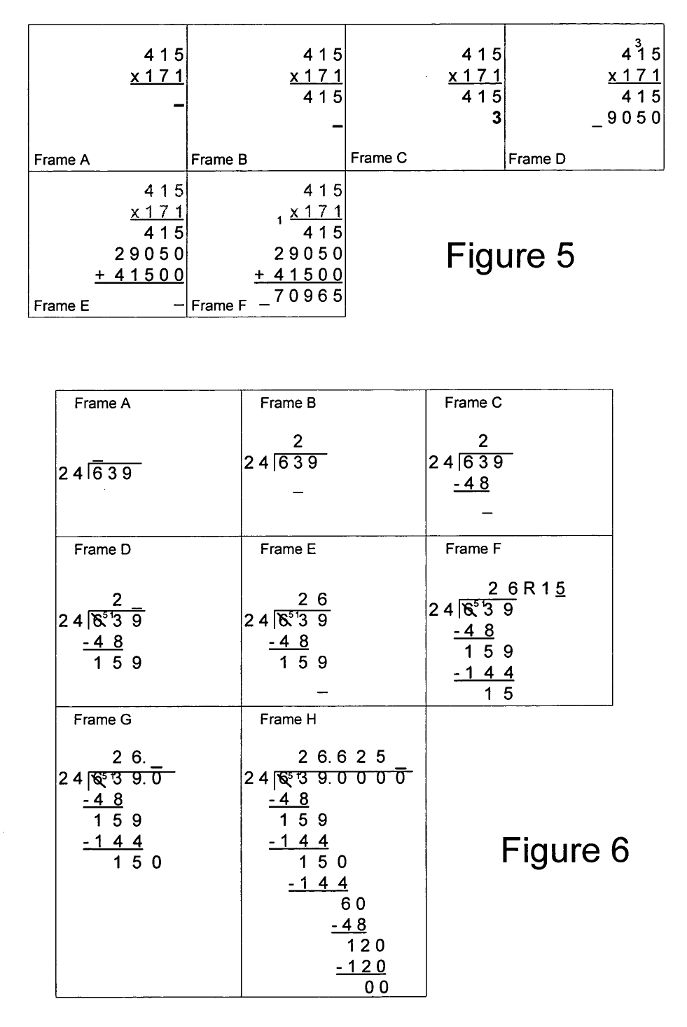

FIG. 5 shows a display featuring a multiplication problem in accordance with the present invention. This is the mode provided to allow the student to work out a single or multiple digit multiplication problem. Frames A through F are snapshots taken at several different points as the problem 415×171 is being solved.

Frame A shows the display immediately after the problem has been entered. Again, the cursor is underneath the rightmost column of numbers. This example actually illustrates a case in which a student might decide not to work the problem right to left. Since the first sub-problem is 415×1, the student might recognize that this is just 415, and choose to arrow over until the cursor in under the 4, and enter the digits left to right. This level of flexibility goes back to the basic design principal behind the invention: to allow students to work the problem on the handheld device just as they would on paper.

Frame B shows the state of the graphical display after the first row has been solved. The cursor is moved back to the rightmost column. Frame C shows what happens when the students make a mistake. In this case the student knows that 7×5 is 35 but has forgotten to enter the trailing zero needed in the second row of a multi-digit multiplication. For purposes of illustration in the present example, the incorrect digit (3) in the second row is depicted in bold. However, on the actual display screen the incorrect digit may be displayed in red, and an accompanying audible error indication may also be added.

In addition to providing an error signal, the invention can also provide the user with a hint. This hint may comprise a reminder regarding a specific mathematical rule and/or a reference to textbook page.

Frame D shows the state of things right before the last digit in the second row is entered. Note that the 3 in the first sub-problem (7×5=35) has been carried to the second column.

Notice also, that the 1 resulting from the second sub-problem (7×1+3=10) has not has not been carried to the third column. As explained above, carrying is allowed, but not required;
students are allowed to work as they would on paper.

Frame E shows the graphic display immediately after the third column of multiplication has been performed, before the summation phase begins. Note that the original multiplication has been faded out so that carry digits (in this example, 1) can be seen more easily, as in frame F.

FIG. 6 shows a display featuring a division problem in accordance with the present invention. This is the mode provided to allow the student to work out long division problems.

Frames A through H are snapshots taken at several different points as the problem 639/24=26.625 is being solved.

Frame A shows the display immediately after the problem has been entered. The cursor is at the leftmost of the answer column. In frame B the student has arrowed over once, and entered 2. (Note: the student also has the option of entering a leading zero.) The cursor automatically drops down so that the user can multiply 24 times 2. Multiplication within the wider context of a long division problem works just like multiplication problems described above. While not shown in this example, during multiplication carry digits can be displayed over the digits in the denominator, just as a student would on paper.

Frame C shows the display after the multiplication has been performed. At this point the user performs a subtraction. Subtraction in this context works just like subtraction problems described above. Note in frame D that borrowing is performed the same way. Frame E shows the process repeating for the next digit in the answer.

Frame F shows the problem resolved to a remainder. After the 2 and the 6 have been worked through, the student hits the “R” key, and then types in the remainder.

However, if the student would rather resolve the problem to a decimal, the student hits the “.” key and keeps working the problem. This process is show in frames G and H. While this problem terminates after 26.625, non-terminating decimals can continue to be worked until the screen space is used up.

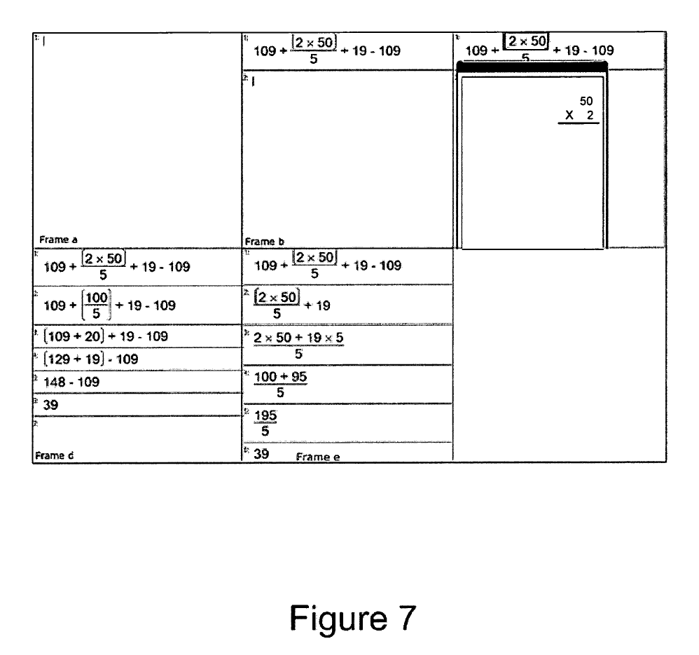

FIG. 7 shows a display featuring the solution of an expression in accordance with the present invention. Frame A shows that before an expression is entered the user is given a blank screen with a flashing cursor. Frame B shows the display after an expression has been entered.

The user hits the return key after entering the expression. If an error is made at any point in this process, hitting the return key will produce an error indication (visible and/or audible) and the student will not be allowed to proceed.

If the expression is valid (i.e. all the operators have the right number of operands, parentheses match, etc.), the user is given another line on which to work. The student has several different options at this point.

If the student can do the arithmetic in his head, he can proceed rewriting this expression, step by step, until it is resolved. Most of the time students will not be able to perform the arithmetic portions of these steps in their head, in which case they can use the calculate feature. The calculate feature works in two modes: manual and automatic.

In the manual mode, the student selects the portion of the expression to calculate, as shown in frame C, and selects the calculate menu option. The selected portion of the problem pops up in the solution modes described above.

In the automatic mode, the result is automatically calculated and inserted into the expression. Frame D shows this entire problem worked out with auto calculation. The expression calculated in each step is shown in parentheses. This mode of operation does not force the user to solve the expression in any particular way. As long as the basic rules of arithmetic and algebra are followed, the student can proceed.

Frame E shows an alternate way that this expression might be solved. In step 2, the user notices that 109 is added and subtracted from the expression, so they are dropped. In step 3, the student finds a common denominator (5).

In addition to the arithmetic problems described above, the present invention also works for algebra problems. As with the arithmetic problems, the invention monitors student choices as the student walks through the steps of solving a problem and notifies the student as soon as a mistake is made. However, due to the more complex nature of algebraic rules, when the student is notified about a mistake, the invention will attempt to detect the type of error made and offer hints as to the correct operation and/or provide a link to a textbook section for review.

In the present example, the input to the program is a sequence of algebraic statements, i.e., s[0], . . . , s[n−1]. These statements are entered one at a time, and the program remembers all previous statements. There are three types of statements: LET, THEREFORE, and DONE.

The following is an example of user input, in which the student has been asked to solve for x:
s[0]: xy=x+y
s[1]: xy+x=y
s[2]: xy−x=y
s[3]: x(y−1)=y
s[4]: x=y/(y-1)
s[5]: let y=4
s[6]: x=1⅓
s[7]: done

In the above example, n=8. The first input statement is always assumed to be a LET statement. Subsequent statements are assumed to be THEREFORE statements, unless the statement begins with the keyword LET. Note that statement s[1] is an error. The user enters the algebraic statements one at a time and is given either positive or negative feedback after each step.

The following is an example of a user interaction with the invention within a text environment:
s[0]: xy=x+y
s[1]: xy+x=y
   →No, check your signs.
s[2]: xy−x=y
   →Yes, you subtracted x from both sides.
s[3]: x(y−1)=y
   →Yes, you factored out an x.
s[4]: x=y/(y−1)
   →Yes, you divided both sides by y−1.
s[5]: let y=4
   →Ok.
s[6]: x=1⅓
   →Yes, you performed a simple arithmetic operation.
s[7]: done
   →Goodbye.

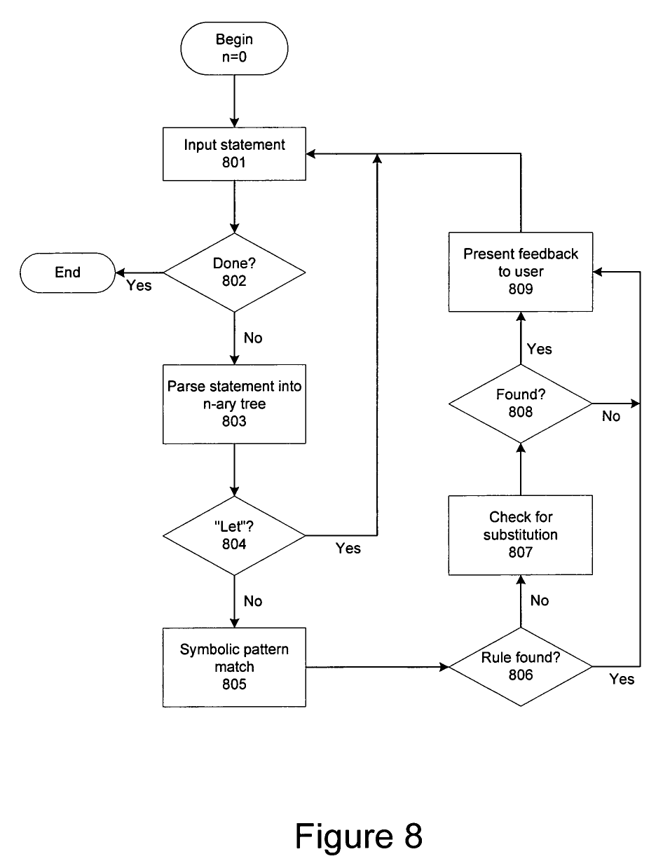

Referring now to FIG. 8, a flowchart illustrating the process of monitoring student input and providing feedback is depicted in accordance with the present invention. The process begins at n=0 with the initial LET statement; using the above example, s[0]: xy=x+y. The student then enters the next statement (step 801). The program checks to see if the statement entered by the user is a DONE statement (step 802). If the statement is DONE, the student is finished and the process terminates. If the statement s[n] entered in step 801 is not DONE, the invention parses it into an n-ary tree (step 803).

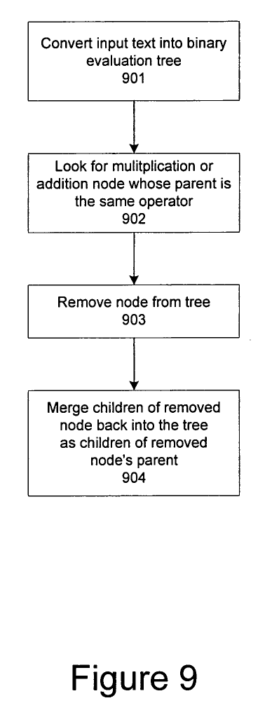

FIG. 9 is a flowchart illustrating the steps of converting the input statement into an n-ary tree. The first step in this process is to convert the input text, s[n], into a binary evaluation tree (step 901). For example, the binary evaluation tree for the statement s[n]: x=a+b+c would be:

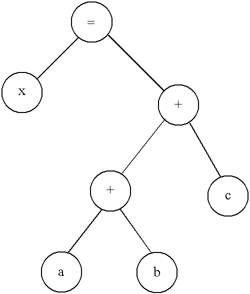

The present invention deviates from standard generation of binary evaluation trees in two ways. First, subtraction operations are converted to addition of minus values, e.g., x−5 becomes x+(−5), which simplifies later processing. Second is to support implicit multiplication. In this way, users my simply enter xyz (wherein the multiplication to these operands is assumed) rather than having to enter x*y*z. The invention takes care of this by preprocessing the input to this block. All tokens are scanned looking for operands, and if two operands are found together (without an operator between them), a multiply operator is inserted.

This feature can be turned off to support user interfaces that allow the user to use multiple character variables (e.g., “profit=revenues−expenses”). When in this mode, a space between operands is treated like the multiplication operator (e.g., Force=Mass Acceleration).

After the binary tree evaluation is built, the program searches the tree from the bottom up and left to right, looking for a multiplication or addition node whose parent is the same type of operator (step 902). If such a parent node is found, the child node is removed from the tree, since it is redundant (step 903). Finally, the children of the removed node are merged back into the tree as children of the removed node's parent (step 904). Using the example tree above, the addition node linking “a” and “b” has a parent node that is also an addition operator. Therefore, the child addition node is removed. The “a” and “b” nodes then become children of the parent addition node. The final n-ary tree would look like the following:

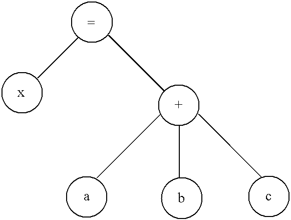

Returning to the flowchart in FIG. 8, after the n-ary tree is built, the program determines if the statement in question is a LET statement (step 804). As explained above, the beginning statement, s[0], is assumed to be a LET statement. Any subsequent LET statement must be explicitly denoted as such by the user. If the statement in question, s[n], is a LET statement, the program returns to step 801 and retrieves the next statement.

If the statement, s[n], is not a LET statement, the program performs a symbolic pattern match (step 805). Symbolic pattern matching involves comparing the statement in question, s[n], to the previous statement, s[n−1], and producing a result, r[n], indicating whether or not s[n] does indeed follow from s[n−1]. Symbolic pattern matching comprises three main sub-processes: 1) removal of extraneous sub-expressions, 2) refactoring common sub-expressions, and 3) rule comparison.

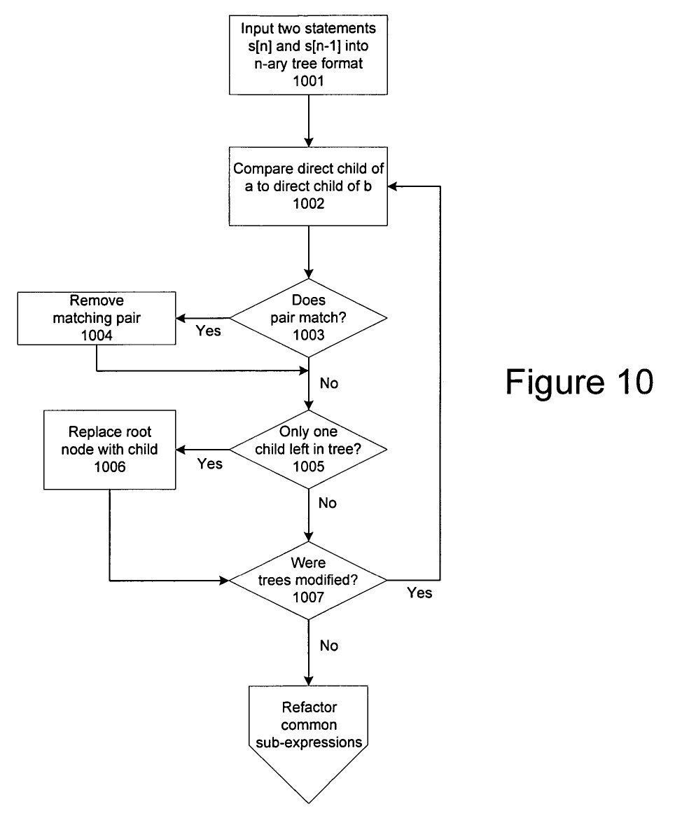

FIG. 10 is a flowchart illustrating the process of removing extraneous sub-expressions.

The two statements being matched, s[n] and s[n−1], are input into n-ary tree format (step 1001).

For this example, the root nodes of these trees will be called “a” and “b”. The program compares all of the direct children of node “a” to the direct children of node “b” (step 1002) and determines if any pair of children matches (step 1003). If a pair of direct children nodes does match, they are removed (step 1004).

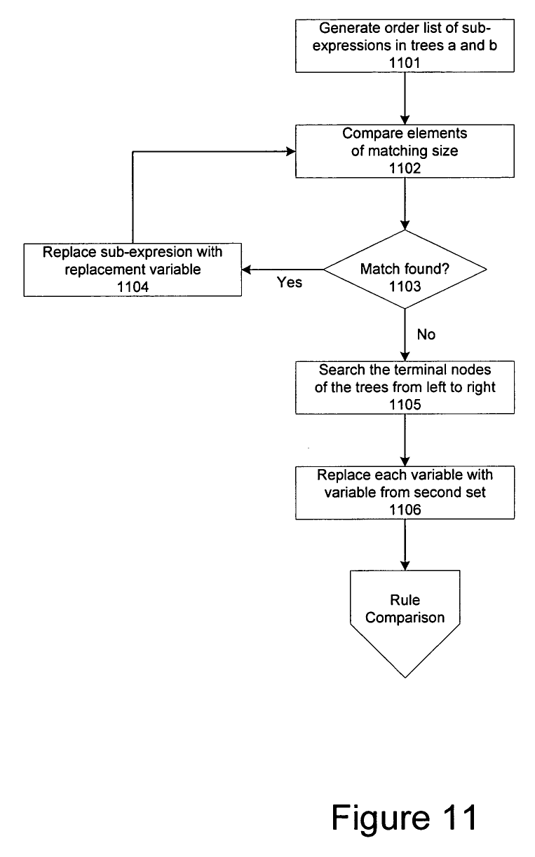

After the matching children have been removed, the invention determines if either node “a” or “b” is left with only one child (step 1005). If so, that node is replaced by the child node (step 1006). The invention then determines if a modification was made to the trees in the previous steps (step 1007). If the trees were modified, the process returns to step 1002. Otherwise, the process ends, and the program then proceeds to the process of refactoring the common sub-expressions (explained in more detail in FIG. 11 below).

The following example will help illustrate the process depicted in FIG. 10 for removing extraneous sub-expressions. The two statements being matched are:
s[n−1]: 15x+17xy+cy=17
s[n]: x(15+17y)+cy=17
   Since 17 is a common child node in the tress for both statements, it is removed. The equal sign (=) is also removed because the left hand sign+is the only child remaining. Therefore, after the first iteration, the statements are:
s[n−1]: 15x+17xy+cy
s[n]: x(15+17y)+cy
   Since “+cy” is common to both trees, it is also removed. Thus, after the second iteration, the statements are now:
s[n−1]: 15x+17xy
s[n]: x(15+17y)

FIG. 11 is a flowchart illustrating the process of refactoring common sub-expressions in the statements after the extraneous sub-expressions have been removed. This is the second main sub-process in symbolically matching the statements in step 805 of FIG. 8.

The term refactor is a concept well known in computer programming. Refactoring code involves taking a part out of the code, segregating it into its own routine, and then calling the routine from the original code. It is a standard way of simplifying computer code. The present invention applies the concept of refactoring to algebraic statements.

The process starts with the two statements (i.e., s[n] and s[n−1]) in an n-ary tree format, wherein extraneous sub-expressions are already removed (as described above). Again, the root nodes of the n-ary trees can be called “a” and “b”, respectively. The invention generates an ordered list of all sub-expressions of “a” and “b” in order from largest to smallest (step 1101). The program then walks through this list, comparing elements of matching size (step 1102) and determines if a match exists between the sub-expressions (step 1103).

If a match is found between two sub-expressions in the two trees, all occurrences of that sub-expression in both statements are replaced with a variable from a pre-defined list (e.g., A, B, C, . . . , Z) (step 1104). The process then returns to step 1102 and looks for more matches, ignoring any sub-expressions that contain replacement variables.

The following example will help illustrate the above steps. Using the same example statements above, the input statements to be refactored are:
s[n−1]: 15x+17xy
s[n]: x(15+17y)
   Refactoring moves from the largest opportunities to the smallest. The largest common sub-expression in both statements is 17y. This sub-expression is replaced with a new variable A. The resulting statement then read:
s[n−1]: 15x+Ax
s[n]: x(15+A)
   The next largest common sub-expression in s[n] and s[n−1] is 15, which is replaced by the variable B. The statements now read:
s[n−1]: Bx+Ax
s[n]: x(B+A)
   Finally, the smallest common sub-expression is x, which is replaced by the variable C, producing the following statements:
s[n−1]: BC+AC
s[n]: C(B+A)

Returning to FIG. 11, the steps for variable substitution begin after all of the common sub-expressions have been refactored. After all common sub-expressions are replaced with variables, the variable are reordered and substituted with new variables. This is done strictly for readability. Using the n-ary trees, the program searches the terminal nodes from left to right (step 1105), and each time a variable in the original defined set (i.e., A, B, C, . . . , Z) is found, all occurrences of that variable in the trees are replaced with the next available replacement variable in a second defined set (i.e. a, b, c, . . . , z) (step 1107). For example, continuing with the same example above, the first set of variables is replaced with another set of variables as follows:
B→a
C→b
A→c
   This variable substitution produces the following end product:
s[n−1]: ab+cb
s[n]: b(a+c)

After the common sub-expressions are refactored, the final main element of step 805 in FIG. 8 is to compare the resulting statements to defined mathematical rules. By this point in the process, the user's input has been converted into a general form that one might see in a textbook to describe different types of algebraic operations. For example, a textbook might describe the difference of squares formula as:
a²−b²=(a+b)(a−b)
The invention compares the statements produced at the end of step 1107 to a database of known legal and illegal general forms.

Each record in the database of general forms describes a single operation, indicates whether the operation is legal or illegal, and gives a text description of the operation and an ordinal number for the operation. The following is an example record:

| Field-1 | Field-2 | Field-3 | Field-4 | Field-5 |
|---|---|---|---|---|
| a(b_+ . . .)˜ | 016 | Distribution | + | Yes, you |
| (ab_+ . . .) | | | | distributed <a> |

Field 1 defines the algebraic rule. A tilde (˜) is used instead of an equal sign (=) to show that one form implies another. The selection of the tilde is arbitrary but different from the equal sign because the equal sign can appear on either side of the rule. In addition, ellipses are used as a generalization of the sum (Σ) and product (┌) symbols that often appear in such rules.

Field 2 is the ordinal number of the rule, which provides a unique identifier for that rule within the database.

Field 3 is a description or name of the rule.

Field 4 contains a plus or minus sign. A plus indicates that the operation is valid, while a minus sign means the operation is invalid. Invalid operations are included in the database to account for common operation errors made by students. Being able to match a student's choices (i.e. statements) with an invalid rule helps to identify specifically what the student did wrong and thus provide better feedback.

Field 5 contains a longer description of the rule. The variable from Field 1 (i.e. a) appears enclosed within the greater than and less than symbols. This field is used to provide the user specific feedback in step 809 in FIG. 8 (described below). The variables are replaced before this string is presented to the user. For example, if the user entered the following step:
s[n−1]: xy(a+b+c+d)
s[n]: axy+bxy+cxy+dxy
   The string in Field 5 would be expanded to read “Yes, you distributed xy.” This is done by means of macroprocessing, which is well known in the art.

Returning to FIG. 8, the process of symbolically pattern matching a statement to the database of operations does not necessarily mean a corresponding rule will be found. Therefore, the program must determine if a rule can be found that matches the statement input by the user (step 806). If a rule is found in the database, the rule is presented to the user (step 809).

There are three possibilities resulting in the feedback provided to the user in step 809. The invention will either find a valid rule, an invalid rule, or no rule at all. The first two cases are treated the same. Any variables in the rule that are surrounded by greater than or less than signs (see table above) are replaced with the actual values in the statement in question and presented to the user.

Once the software detects the rule that the user is applying, there are several options for additional feedback. For example, the software may provide a page reference to a textbook. The invention may also provide a link into a help system or a link to a tutorial page which might show other ways of applying the rule. This information can also be stored in a database so that a teacher can review the concepts with which a student is struggling or excelling.

If no rule (either valid or invalid) can be found to match the user's input, the invention checks for a substitution (step 807). If a substitution is found, it is used to evaluate the statement input by the user. The following is an example:
s[0]: 2x−3y=4
s[1]: Let 5x+4y=7
   →Ok.
s[2]: 4y=7-5x
   →Yes, you added −5x to both sides.
s[3]: y=(7−5x)/4
   →Yes, you divided both sides by 4.
s[4]: 2x−3[(7−5x)/4]=4
   →Yes, you substituted (7−5x)/4 for y.

Every statement previously entered into the system is retained. In order to perform a substitution check, the program goes back through the list of statements (s[0] . . . s[n−2]) and looks for statements in a specific format:
A=B
   wherein A and B are arbitrary expressions. In the example above, every statement fits this criterion:
s[0]: A=2x−3y, B=4
s[1]: A=5x+4y, B=7
s[2]: A=4y, B=7−5x
s[3]: A=y, B=(7−5x)/4

The program takes these expressions (A and B) and searches for them in the current statement s[n−1]. Referring to the example above, the program would find sub-expression B from s[3] in the statement s[4] and would replace B with A, yielding the following expression:
2x−3[(7−5x)/4]=4→2x−3[y]=4
This expression is s[0], which is revealed by comparing the newly generated statement with every previously entered statement that is not already being drawn upon. For example, if s[4] is the problem, A and B from s[3] are already being used. Therefore, the new expression s[4] is compared against s[0], . . . , s[2] along the lines described above.

The following is a pseudo-code example of the substitution check procedure:

Let N = # of statements
Let I = N − 1
For each i in I

If s[i] matches the general form A = B then

If A can be found in statement s[n−1]

Create new expression X by replacing sub-expression
A with sub-

expression B in s[n−1]

For each j in I

If j <> i then

Compare s[j] to X
If match then terminate with a positive result

End if

End for each j in I

End if
If B can be found in statement s[n−1]

Create a new expression Y by replacing sub-expression
B with sub-

expression A in s[n−1]

For each j in I

If j <> I then

Compare s[j] to Y
If match then terminate with a positive result

End if

End if each j in I

End if

End if

End for each i in I

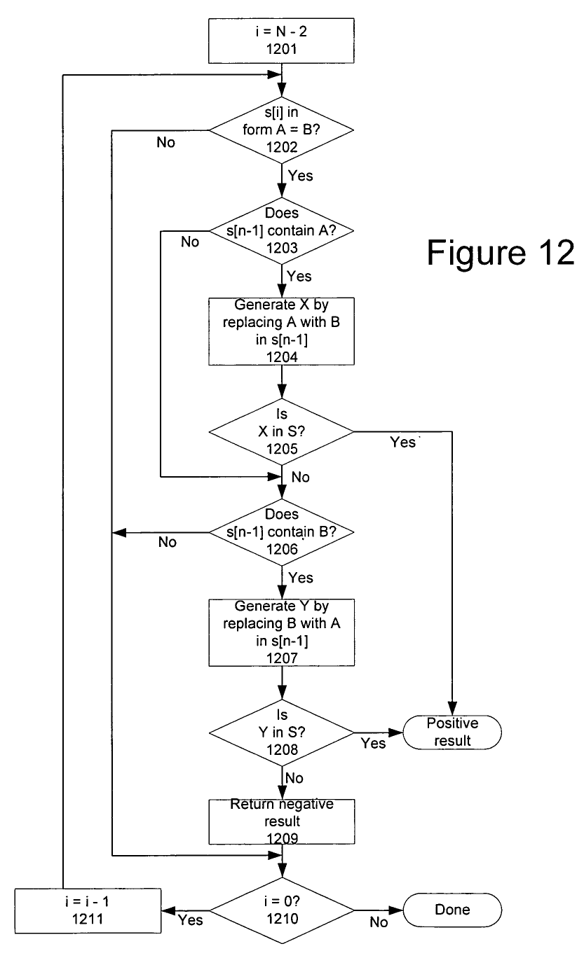

FIG. 12 depicts a flowchart illustrating the substitution checking process in accordance with the present invention. The process begins by assuming i=N−2 (step 1201), and then determines if s[i] is in the form of A=B, as described above (step 1202). If s[i] is not in the A=B form, the process skips it and goes to step 1209.

If s[i] is in the form A=B, the program determines if the current statement s[n−1] contains A (step 1203). If s[n−1] does contain A, a new expression X is generated by replacing A with B in s[n−1] (step 1204). If s[n−1] does not contain A, the process skips to step 1206.

The program then checks if X is in the set S (s[n−1], . . . , s[0]; all of the statements that have been entered so far) to see if a substitution has been made (step 1205). If X is in one of the previously entered steps in S, the check is finished and a positive result is returned. If not, the program determines if s[n−1] contains B (step 1206).

If s[n−1] does not contain B, the process moves to step 1209. If s[n−1] contains B, the program generates a new expression Y by replacing B with A in s[n−1] (step 1207). The program then determines if Y is in the set S (step 1208). If Y is in S, the check is finished and a positive result is returned and the process ends.

If Y is not in S, the program returns a negative result (step 1209). Since a substitution has not yet been found, the program continues counting down from i=N−2 to i=0. The program determines if i=0 (step 1210). If so, there are no more statements in set S to evaluate, and the process is done. If i does not equal zero, then i is set to i−1 (step 1211) and the process returns to step 1202.

The following example will help illustrate the process depicted in FIG. 12:
s[0]: 2x−3y=4
s[1]: Let 5x+4y=7
s[2]: 4y=7−5x
s[3]: y=(7−5x)/4
s[4]: 2x−3[(7−5×)/4]=4
   In the first pass through the process flow, N=5, therefore i=3 (step 1201). The answer to question 1202 is yes, since s[3] is in the form of A=B:
s[3]: y=(7−5x)/4
A=y
B=(7−5x)/4
   Proceeding to question 1203, the answer is no, because A =y, and s[4] does not contain y. Moving to question 1206, the answer is yes, because B=(7−5x)/4, and s[4] does contain that sub-expression. Therefore, the program generates expression Y by replacing B with A in s[4]:
Y: 2x−3[y]=4
   As can be seen, expression Y is the same as s[0]. Therefore, the answer to question 1208 is yes, since Y is in set S. This terminates the algorithm with a positive result, there has been a substitution.

Returning to FIG. 8, if no substitution can be found, a generic unknown error is returned to the user in step 809. This rule (ordinal 0) has the description “No”.

After the feedback is presented to the user in step 809, the process returns to step 801 and the user enters the next statement. If the user enters “done”, the process ends.

With the present invention, the user does the work, but the invention informs the user if that work is going in the right direction with each step, rather than simply providing an all or nothing answer at the end.

At the higher grade levels there are a variety of tasks in the math curriculum that do not boil down to solving problems step by step. Graphing inequalities and functions are two examples of these.

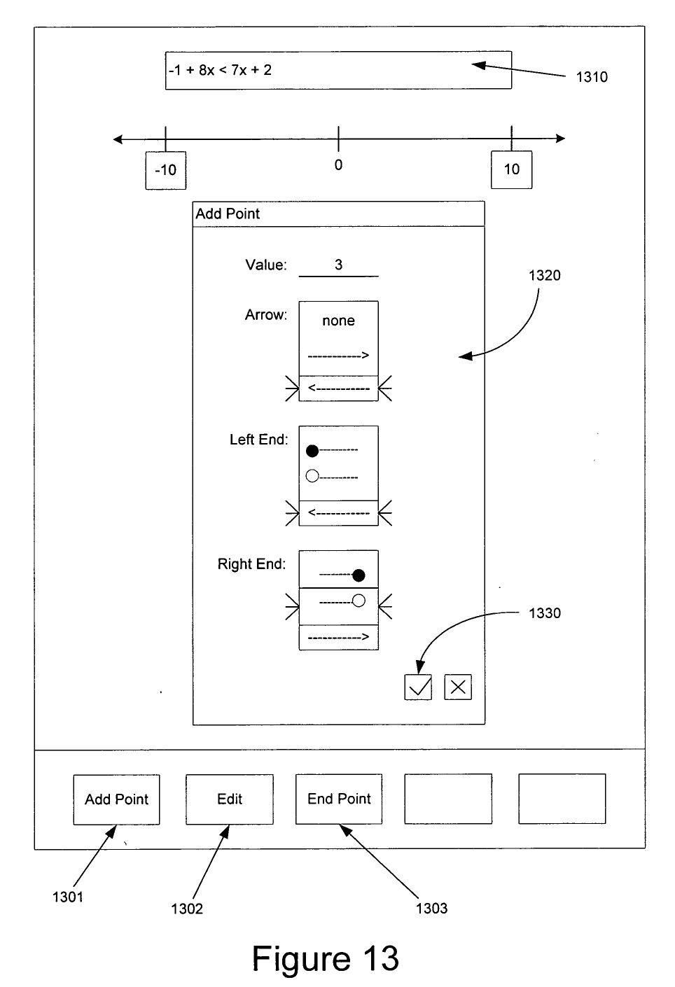

FIG. 13 shows the user interface for graphing inequalities. Note that the soft keys 1301-1303, which are a part of the reference hardware design, are drawn at the bottom of this figure. These are shortcuts for the several menu options which are necessary for graphing inequalities.

The box 1310 at the top of the illustration contains the inequality to be graphed (−1+8x<7x+2). This inequality cannot be graphed in its original form. The “Edit” soft key 1302 will bring up the inequality in the expression display, described above in regard to FIG. 7. Once the student has put the inequality into a graphable form (x<3 in the present example) he can then place points on the graph. The “Add Pt.” soft key 1301 does this by bring up the dialog box 1320 shown in FIG. 13. This dialog box allows the student to specify the location and line style of a new graph point. The “End Pts” option 1303 allows the student to set the left and right end points on the graph.

When the student has completed the exercise, and has drawn a graph that he believes matches the inequality, selecting the check menu option 1330 on the handheld will check his work.

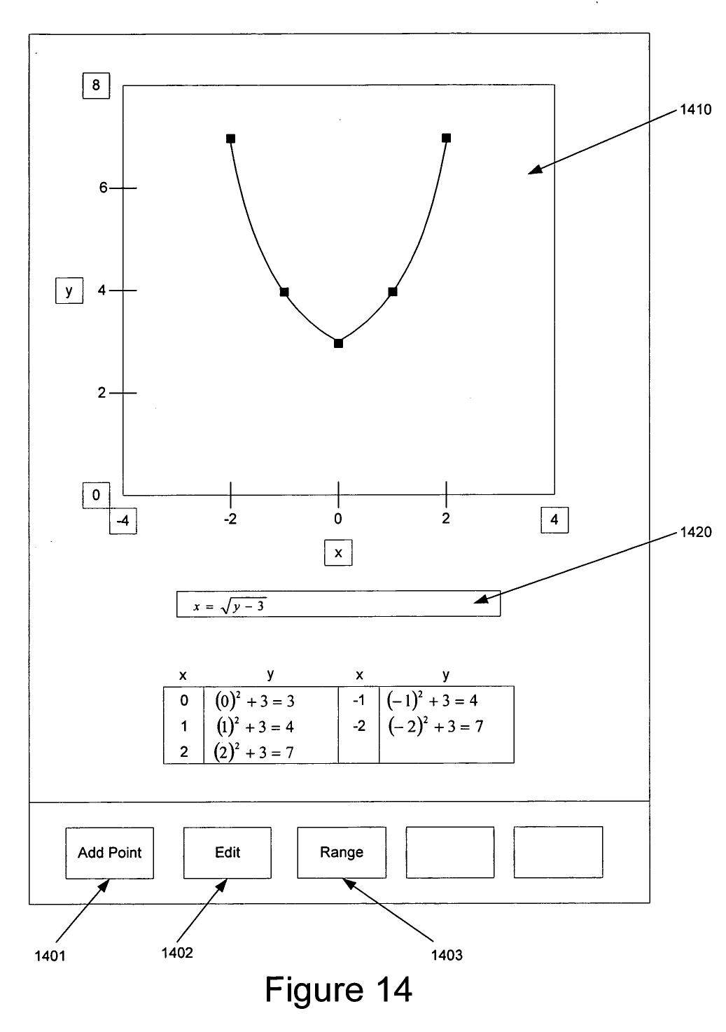

FIG. 14 shows the user interface for graphing functions. As with graphing inequalities, several menu options are necessary to operate this interface.

The top section of the display 1410 shows the graph as it is being constructed. The box in the center 1420 shows the function to be graphed (x=\sqrt{y−3}). As with the initial inequality in FIG. 13, this function is not in the proper form to be graphed. The “Edit” soft key 1402 will bring up the expression display, as was describe above with respect to graphing inequalities. Once the function is in a form to be graphed, the “Add Pt.” menu function 1401 adds a point. The user supplies the x value, and then substitutes that into the equation and solves (using the expression mode) for y. Once x and y are know, the point is displayed on the graph. The software automatically interpolates between the points that the user supplies. While the calculator draws the line, it is up to the student to pick enough points, and the correct points, to display the graph in sufficient detail.

The “Range” menu option 1403 allows the student to set the X and Y ranges to be graphed.

In lower grade levels there are a variety of subjects lumped into the math curriculum that are not traditional math subjects per se. Reading clock faces, working with time, and money are several examples. The present invention has modes to work on these subjects as well.

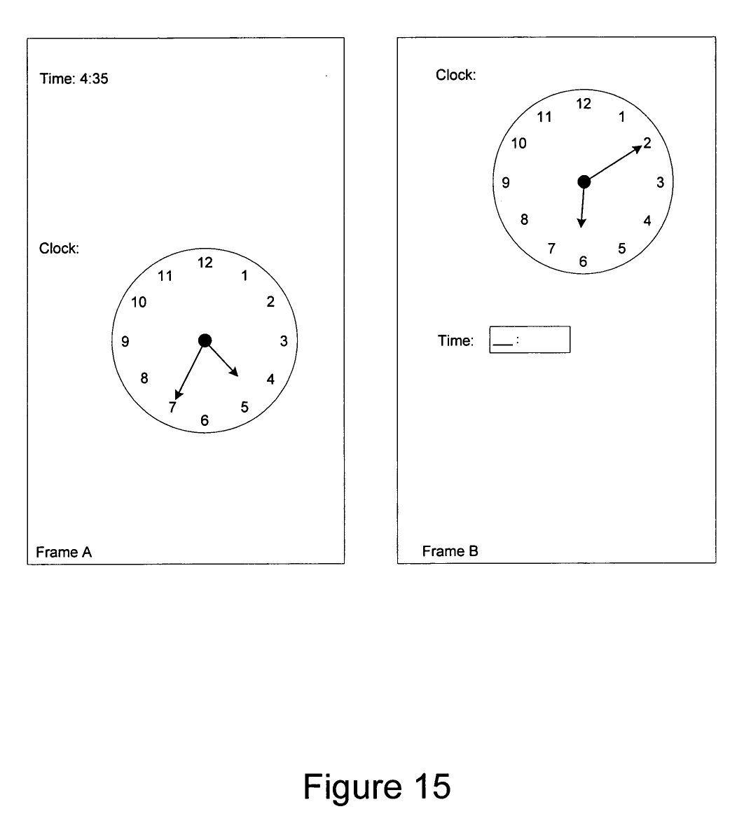

FIG. 15 shows two methods of working with clocks. In frame A the student is shown a time (4:35) and asked to set the clock hands to that time. The up and down arrows of the D Pad will move the hour hand. The left and right arrows will move the minute hand. The student hits the action button when the time has been set. If a mistake is made, the device returns an error indication.

Frame B works in the other direction. The student is shown a time on a clock face and asked to write out the time using the number and cursor keys.

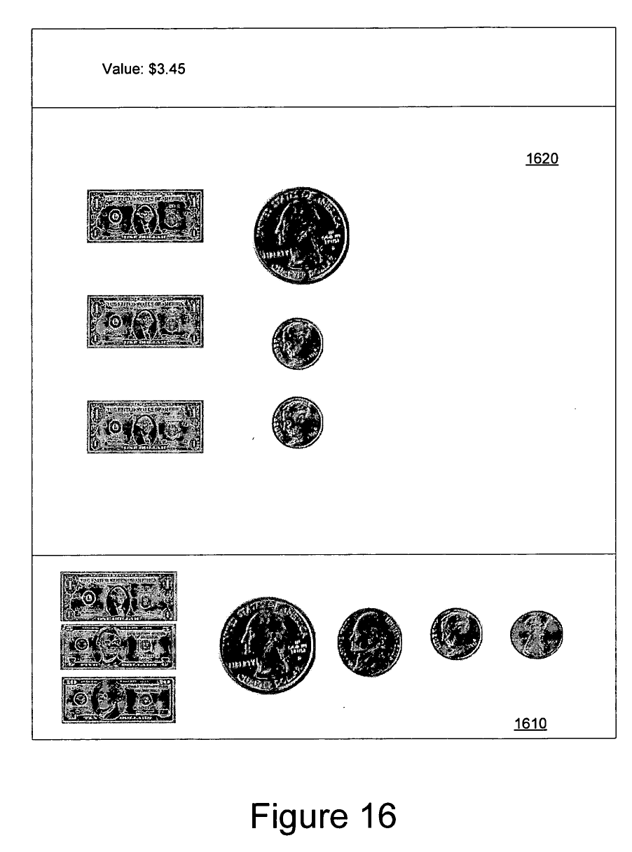

Money is another topic commonly working into the early math curriculum. FIG. 16 shows an interface for working with bill and coin denominations. In the present example, the student is asked to count out $3.45. The bottom section of the display 1610 shows the available denominations of both bills and coins (this might change from one problem to the next). The left and right arrow keys of the D Pad move the selection between the various listed denominations. Hitting the up arrow moves the selected denomination into the center section 1620. When the center section contains the correct combination of coins and bills, the student hits the action button to check his work.

Because the software actually has modes for the various types of problems encountered in a math curriculum, the present invention has the ability to store an entire assignment (or library of assignments) in the handheld device. The assignment one would normally see at the end of a textbook section can be included on a software cartridge, and the user can pull it out of an assignment list under a menu option. Because the invention can store the entire assignment, it is possible to maintain assessment data.

Assessment data is nothing more than keeping track of the discrete steps that the student gets correct and incorrect. For example, if the student is working through a multiplication problem he might correctly recall the following math facts:
7×3=21
7×2=14
3×3=9
3×2=6
   And he might miss:
7×8=56
8×3=24

From this information (number of correct and incorrect steps) a grade can be calculated. This information can also be presented to a teacher, tutor or parent, who might realize that the student is weak on multiplication tables for 8's.

Assessment data for algebra would simply involve storing which correct steps and which incorrect steps the student followed. This allows teacher and tutors to determine which algebraic rules the student is comprehending and which ones the student is failing to grasp (e.g., distribution). Again, the information can be presented in raw form or aggregated into a grade.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

I claim:

1. A handheld computing device for solving math problems, comprising:
input means for receiving input from a user;
a display; and
a processor;
wherein the device presents a mathematical problem to the user via the display, and wherein the user enters a solution to the problem step by step;
wherein the device monitors user input and evaluates, according to mathematical rules, each solution step entered by the user;
wherein the device returns an error signal if the user enters an incorrect solution step; and
wherein the device returns a confirmation signal if the user enters a correct solution step.

2. The device according to claim 1, wherein the step of returning an error signal further comprises providing the user with a solution hint.

3. The device according to claim 2, wherein the hint is a reference to a mathematical rule.

4. The device according to claim 2, wherein the hint is a reference to at least one of the following:
print textbook;
online textbook; and
online tutorial.

5. The device according to claim 1, wherein the type of mathematical problem may include the following:
addition;
subtraction;
multiplication;
division;
expressions;
algebra;
graphing inequalities;
graphing functions;
telling time; and
calculating money.

6. The device according to claim 1, wherein software for different types of mathematical problems is stored on removable cartridges.

7. The device according to claim 1, wherein the device can store problem assignments.

8. The device according to claim 1, wherein the device records assessment data comprising a record of all correct and incorrect solution steps entered by the user.

9. The device according to claim 8, wherein the assessment data can be used to calculate a grade for the user.

10. A method for monitoring and checking the solution of mathematical problems, the method comprising the computer implemented steps of:
(a) presenting a mathematical problem to a user;
(b) receiving user input of a solution to the problem step by step;
(c) monitoring user input and evaluating, according to mathematical rules, each solution step entered by the user;
(d) returning an error signal if the user enters an incorrect solution step; and
(e) returning a confirmation signal if the user enters a correct solution step.

11. The method according to claim 10, wherein the step of returning an error signal further comprises providing the user with a solution hint.

12. The method according to claim 11, wherein the hint is a reference to a mathematical rule.

13. The method according to claim 11, wherein the hint is a reference to at least one of the following:
print textbook;
online textbook; and
online tutorial.

14. The method according to claim 10, wherein the type of mathematical problem may include the following:
addition;
subtraction;
multiplication;
division;
expressions;
algebra;
graphing inequalities;
graphing functions;
telling time; and
calculating money.

15. The method according to claim 10, further comprising storing problem assignments.

16. The method according to claim 10, further comprising recording assessment data, wherein the assessment data comprises a record of all correct and incorrect solution steps entered by the user.

17. The method according to claim 16, further comprising calculating a grade for the user based on the assessment data.

18. The method according to claim 10, wherein the method is performed on a handheld computing device.

19. A computer program product in a computer readable medium for monitoring and checking the solution of mathematical problems, the computer program product comprising:
(a) first instructions for presenting a mathematical problem to a user;
(b) second instructions for receiving user input of a solution to the problem step by step;
(c) third instructions for monitoring user input and evaluating, according to mathematical rules, each solution step entered by the user;
(d) fourth instructions for returning an error signal if the user enters an incorrect solution step; and
(e) fifth instructions for returning a confirmation signal if the user enters a correct solution step.

20. The computer program product according to claim 19, wherein the fourth instructions for returning an error signal further comprise instructions for providing the user with a solution hint.

21. The computer program product according to claim 20, wherein the hint is a reference to a mathematical rule.

22. The computer program product according to claim 20, wherein the hint is a reference to at least one of the following:
print textbook;
online textbook; and
online tutorial.

23. The computer program product according to claim 19, wherein the type of mathematical problem may include the following:
addition;
subtraction;
multiplication;
division;
expressions;
algebra;
graphing inequalities;
graphing functions;
telling time; and
calculating money.

24. The computer program product according to claim 19, further comprising instructions for storing problem assignments.

25. The computer program product according to claim 19, further comprising instructions for recording assessment data, wherein the assessment data comprises a record of all correct and incorrect solution steps entered by the user.

26. The computer program product according to claim 25, further comprising instructions for calculating a grade for the user based on the assessment data.

27. The computer program product according to claim 19, wherein the program runs on a handheld computing device.

28. The computer program product according to claim 27, wherein software for different types of mathematical problems is stored on removable cartridges.
